(19) United States
(12) Patent Application Publication
(10) Pub. No.: US 2012/0246152 A1
(43) Pub. Date: Sep. 27, 2012

(54) JURY RESEARCH SYSTEM

(75) Inventor: William Kent Hughes, Austin, TX (US)

(73) Assignee: TRIALSMITH INC., Austin, TX (US)

(21) Appl. No.: 13/490,574

(22) Filed: Jun. 7, 2012

Related U.S. Application Data
(63) Continuation-in-part of application No. 12/769,184, filed on Apr. 28, 2010.
(60) Provisional application No. 61/173,361, filed on Apr. 28, 2009.

(51) Int. Cl. G06F 17/30

(52) U.S. Cl. 707/722; 707/E17.014

(57) ABSTRACT

A system and method for obtaining information on individuals including jurors and providing a variety of reports via the Internet in a rapid manner. The reports can be compiled and reviewed simultaneously by multiple users and notes can be included on the report format. The user may customize the information searched and presented.

### PRIOR RELATED APPLICATIONS

This is a Continuation-in-Part of U.S. application Ser. No. 12/769,184, filed on Apr. 28, 2010, which is a Non-Provisional application of U.S. Provisional Application No. 60/173,361, filed Apr. 28, 2009, both of which are hereby incorporated by reference in their entirety.

### FEDERALLY SPONSORED RESEARCH STATEMENT

Not applicable.

### REFERENCE TO MICROFICHE APPENDIX

Not applicable.

### FIELD OF THE INVENTION

The Field of the Invention relates to using and searching publicly accessible and other available databases to review quickly information on individuals via the Internet. Reports of relevant information are prepared in a form that can be sent via the Internet. The field can be for any type of search where individual information is relevant such as jury research and selection.

### BACKGROUND OF THE INVENTION

Rapid gathering and review of personal information is often necessary in processes including jury selection. There are multiple databases that vary from state to state and county to county inside each state. In addition, there are national databases for credit information and the like that are helpful in making an evaluation of a suitable juror. However, often the list of jurors is not available long in advance of a trial and the lawyers making the selection have little information that is routinely provided by the juror during the selection process. The lawyers typically have a limited time to question the jurors to obtain important information needed for the jury selection process.

Technology that can quickly access information on each juror from a variety of sources and process the information relevant for the selection process would be beneficial for the lawyer at the beginning of a jury trial. This technology would also be helpful for job candidate screening and other instances when quick information on an individual is desired.

### SUMMARY OF THE INVENTION

The invention relates to a method used during voir dire for rapidly processing a list of jurors who may be empaneled to serve on a jury, rapidly assimilating background data from numerous databases and sources simultaneously via the Internet for more than one juror, storing the data assimilated for each juror in a centralized database, allowing the legal team easy access to review juror research from any device connected to the Internet having a standard Web browser to access the centralized database via the Internet, allowing for real-time annotation and comments on specific jurors and specific research findings, allowing for the development and recording of notes and juror questions for each juror, and providing several methods of producing data in the form of output reports, data exports into Excel or PDF, and summaries of background data for each juror. Although the system is designed for analysis of juror information in the time sensitive voir dire process, it can be used for any investigative process to obtain data on individuals in a rapid manner via the Internet. Also, those who would like to receive reports generated by the process of the present invention can order via a third party supplier via email, fax or other delivery method as desired.

In an aspect of the present invention, it is provided a method for collecting and analyzing data on individuals through cloud computing, comprising the steps of: a) inputting, from a local device, at least one identifier specific to at least one individual of interest in a query to at least one remote database, wherein said at least one remote database contains data of individuals and can be accessed remotely over the Internet; b) searching with multiple computers via cloud computing said data of individuals from said remote database that matches the query; c) collecting data of the matched individuals; and d) parsing the collected data into a predetermined format to generate a output report sorted by the individuals of interest that is accessible via the Internet by at least one user.

In another aspect of the present invention, it is provided a method for collecting and analyzing data on individuals through cloud computing, comprising the steps of: a) creating a new case report; b) inputting, from a local device, at least one identifier specific to at least one individual of interest in a query to at least one identification database to obtain an initial identification of potential matches, wherein said identification database contains identification data of individuals; c) inputting, from said local device, said at least one identifier specific to said individual of interest in a query to at least one remote database, wherein said remote database contains data of individuals and can be accessed remotely over the Internet; d) searching with multiple computers via cloud computing said data of individuals from said remote database that matches the query; e) collecting data of the matched individuals; and f) parsing the collected data into a predetermined format to generate a output report that is accessible by at least one user.

The identifier specific to an individual of interest can be the first and last name, the social security number, and/or the date of birth thereof. The local device can be a desktop computer, a notebook computer, or a mobile electronic device such as a smart phone or a tablet computer. The first database can be a database of credit header information that is obtained from major credit bureau. The second database can be any publicly available database that contains the information of individuals, such as a court house record, a DMV database, an estate record and the like. The third database preferably contains the information of only the cases that a certain user has previously worked on so as to prevent undesired access to private information of the individual of interest.

The “predetermined” format can be any format that a user chooses, for example but not limited to, Excel format, PDF format, or other commercially available format that is suitable for viewing the output report.

### BRIEF DESCRIPTION OF THE DRAWINGS

FIG. 1 is an example of the case listing utilizing the jury research system.

FIGS. 2, 3 and 4 are an example of the case information and juror parameters used by the invention.

FIG. 5 is a sample Juror Initial Identification Search Screen.

FIG. 6 is a Juror Listing Based on Jurors' Identified in ID Process.

FIG. 7 is a Detailed View of Juror Data by Juror Number

FIGS. 8 and 9 are samples of the Output Report.

FIG. 10 is a sample of the Juror Renumbering Tool.

FIG. 11 is a sample of the Juror Filtering Feature.

FIG. 12 is a sample of the Ask a Colleague Feature.

FIG. 13 is a sample of the Juror Report Export Options.

FIG. 14 is a Juror Card Export with Custom Fields

FIG. 15 is a sample of the juror questions with notes.

FIGS. 16a, 16b and 16c is a schematic of the Jury Research System.

### DETAILED DESCRIPTION OF THE INVENTION

The following is a description of a Jury Research System (sometimes referred to as “system”). This system can be used by lawyers and those working with lawyers including jury consultants, paralegals, investigators and other trial team members to quickly assess a complete profile on each prospective juror in a case. The term “user” herein means anyone who is accessing the system. With this additional background information on each juror, the lawyer has more data to assist in questioning (voir dire) and selecting jurors. A jury pool often includes 60 to 120 potential jurors. During voir dire, background information on each juror can assist the legal team in obtaining information that may lead to disqualifying jurors to serve, in preemptive strikes of jurors, and in aiding the legal team in identifying potential bias or prejudice in prospective jurors.

The system provides for rapid retrieval, organizing and storing juror information from disparate sources, and databases so that consultants, paralegals and lawyers can review information simultaneously on jurors in a single Internet-based system.

The jury research system allows the aggregation of data from many sources including but not limited to publicly available databases. The sources can be unlimited and each may be defined and integrated by the lawyer into the jury research system's application program interface (“API”) as part of the search criteria for each juror search performed. Data is retrieved from various sources, parsed into a format that can be stored for each juror, filtered to eliminate duplicates or data not needed for reporting, and stored in a uniform format that is easily analyzed and annotated by the lawyer.

The jury research system allows for unique data to be automatically gathered based on the state of residence or former residence of the juror. For example, some states may have different data, databases, Web sites and other resources that are unique to that state. The system allows for customization of these searches that are dependent on the geographic area of the residence of the juror including voter history.

The jury research system streamlines the process of organizing and storing information from disparate databases, Web sites and Internet-based resources, and providing for a centralized place to store the data and to access and annotate the data by the user.

The system is a web-based access service. The jury research system will be accessible through the World Wide Web using existing technology to access the Internet. The Internet is required to access the system. The system will be compatible with all major Internet Web browsers and compatible on both Macintosh® and PC computers and other devices including IPads® and other tablet devices.

Access to a Web browser allows the user to practice the invention. The user does not need to install any software other than the standard Web browser, unlike applications that are installed on a computer and require native software and data updates. Web-based access will allow the users (lawyer, paralegals and jury consultants) to have simultaneous and remote access to all data. Utilizing a Web based solution, more databases from disparate sources can be accessed simultaneously and aggregated by utilizing multiple servers that may be deployed to speed research queries, allow for simultaneous search activities and for improved performance through distributive processing. As additional databases are created that would provide information relevant to juror information, they can be accessed by the system.

Any user can be designated in this invention to perform these functions. If the term lawyer is used to describe a feature it is understood that any other designated user such as a paralegal or consultant can perform the same function and/or task.

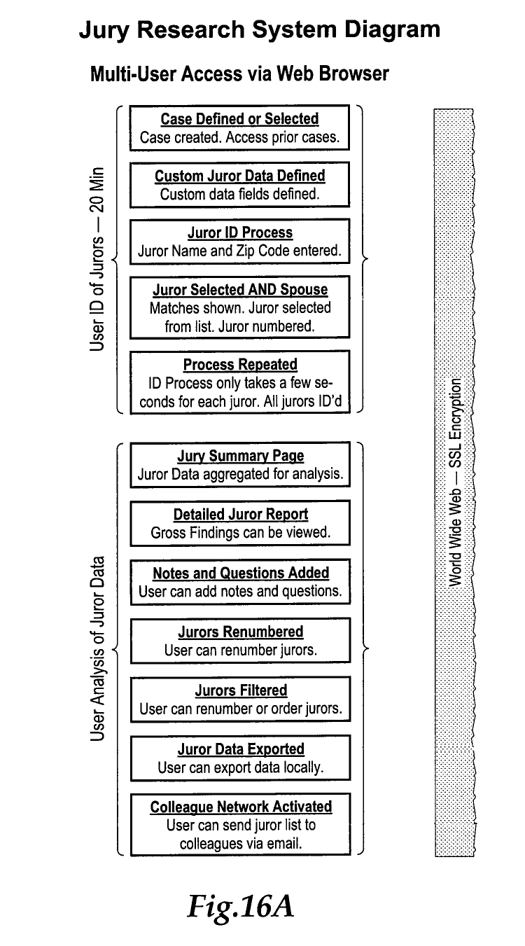

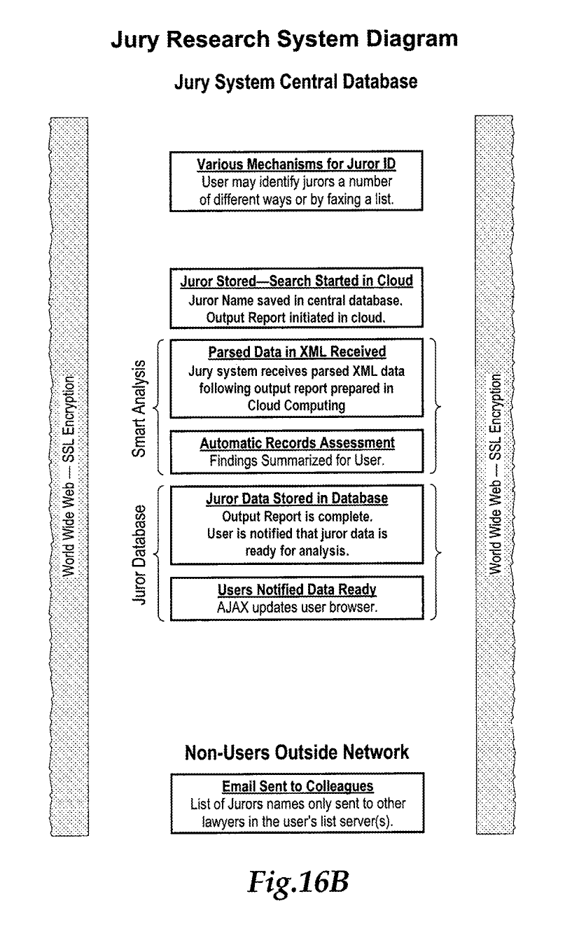

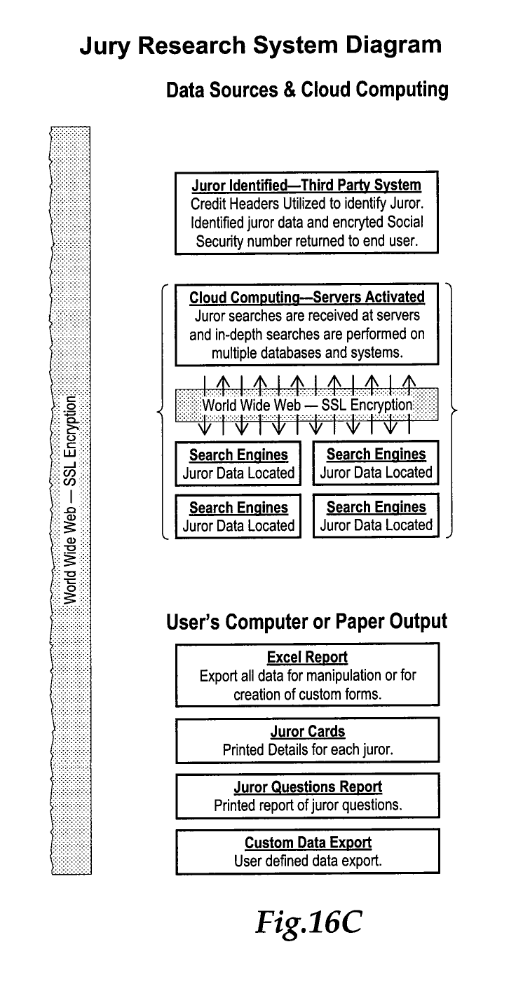

The jury research system uses interface features to enhance usability and speed of operation. For example, AJAX (Asynchronous JavaScript and XML) and JavaScript functions are utilized in the browser interface to update fields, tags and other toggles in the user interface, thereby reducing Web page reloads and to increase the speed of use by end-users. This is achieved because queries can be performed, searches initiated, databases updated and the users notified through Web pages that are not required to reload with every click. These functions save time by reducing bandwidth needed to reload an entire page, and by triggering actions at the main server where in information on the potential jurors is stored, which then launch subsequent searches on queries on secondary servers as shown in FIG. 16B.

Fields can be updated on specific juror information pages without having to post and reload the entire Web page. Fields can be updated and saved by clicking a Save button using JavaScript that does not require the page be reloaded. When pages are refreshed by the user when accessing various functions of the system, the user can see all data that has been updated by other users working on the case, that have already been processed, notes, comments and questions that have been defined by other within the system. For example, if a check box is clicked on the Web page to indicate the juror is “dismissed,” simply clicking the check box will initiate JavaScript that automatically updates the database without having to click a save button on the entire Web page. The AJAX and JavaScript functionality dramatically improves the speed and functionality of the user interface.

Accessing the System

A first-time user of the system or group of users are reviewed and approved to utilize the system to ensure public records and usage compliance with state and federal law.

Upon initial access to the system, each user is provided with a secure User Name and Password to access the system via a standard Web browser.

A secure SSL connection is created between the server and the user's Web browser to protect personal data captured or aggregated and stored for each juror.

Creating a Case

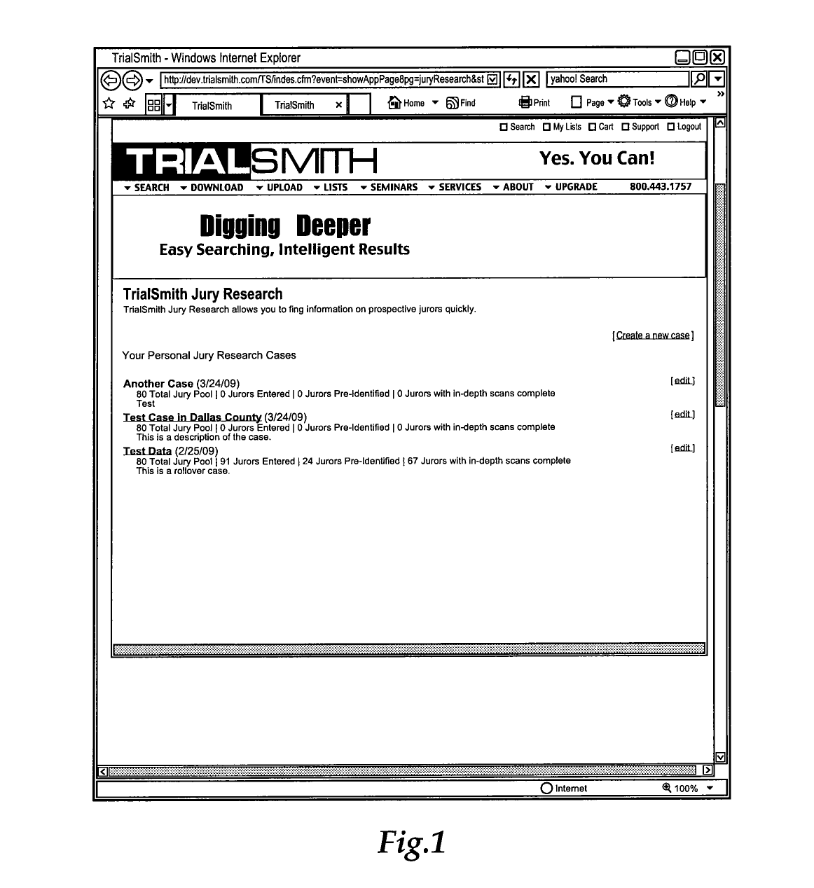

The jury research system is capable of managing multiple cases. Each case is separately defined by the user. Cases can be activated and managed from a single Web-based browser. Each user or groups of users have security controls that limit each user or groups of users to specific cases; users cannot view information on jurors or cases that are owned by other users. The user must initially select a case (See FIG. 1) or define a specific case when first using the system.

The system allows the user to inactivate cases that are concluded, or reactivate a case and its associated data at a future time.

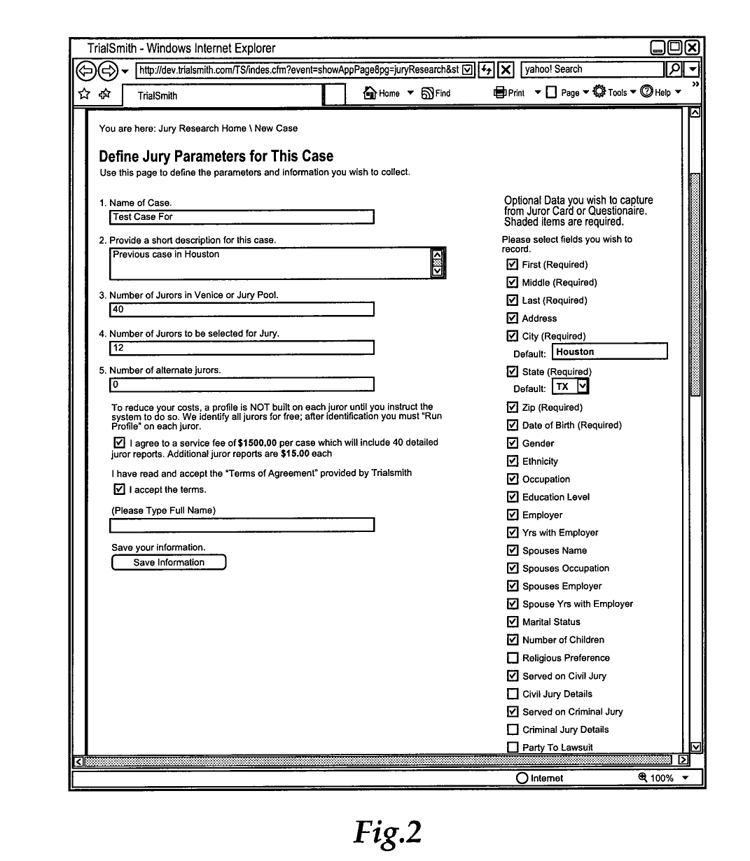

The user can define custom fields and features for each case, which includes parameters for: the number of jurors in the jury pool, the number or jurors to be selected in the case, the number of alternate jurors, and a brief description of the case, as shown in FIG. 2.

The system requires only several standard fields for each juror, which may include First Name, Last Name and State. These fields are required to assist the user in positively identifying jurors in public records.

As shown in FIG. 2, the user can enable or disable standard juror data fields that are commonly found on juror cards or juror surveys provided by the court. These fields can include Address, City, Zip code, Date of Birth, Gender, Ethnicity, Occupation, Education level, Employer, Years with Employer, Marital Status, Spouse Name, Spouse Occupation, Spouse Employer, Spouse Years with Employer, Number of Children, Religious Preference, Served on Civil Jury, Civil Jury Details, Served on Criminal Jury, Criminal Jury Details, Party to a Lawsuit, Lawsuit Details and any other data fields desired by the user.

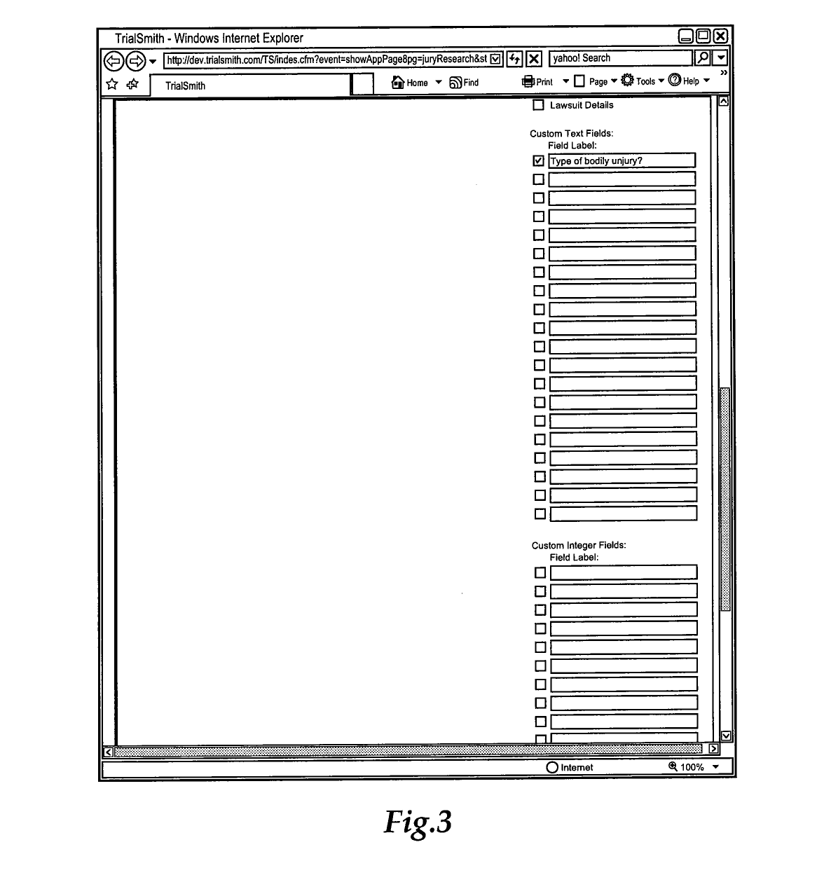

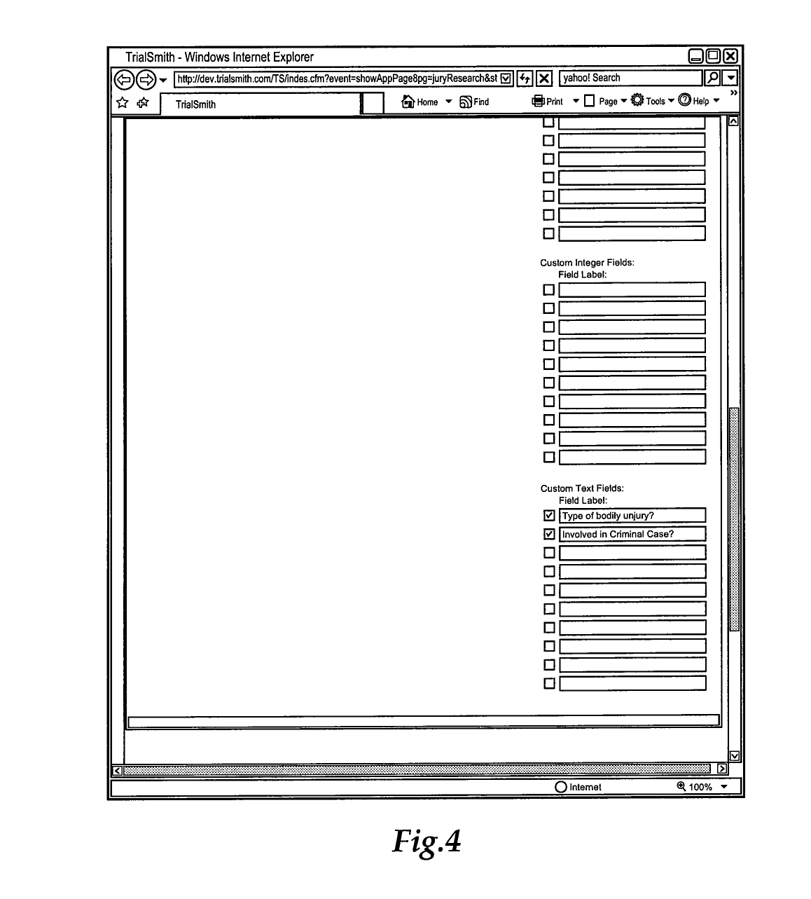

The user can enable additional open text fields for each juror. For example, FIGS. 3 and 4 show that the user can define a label for each open text field, and use the open text field to store information about the juror. The information can be in the form of notes or a sentence using alphanumeric text. These fields can be used to store information from juror questionnaires, juror data that lawyers obtain from sources other than juror or the court, or for the user to store other information or notes as needed for each juror in a sentence or note format.

The user can enable additional numeric fields for each juror. The user can define a label for each numeric field, and use the numeric field to store information about the juror. The information can be in the form of numbers. These fields can be used to store information from juror questionnaires, juror data that lawyers obtain from sources other than juror or the court, or for the user to store other numeric data for each juror.

The user can enable additional True-False fields for each juror. The user can define a label for each True-False field, and use the field to store information about the juror. The field can be used to toggle (True/Yes) or Disable (False/No). These fields can be used to store information from juror questionnaires, juror data that lawyers obtain from sources other than juror or the court, or for the user to code attributes for each juror.

The system allows the user to input data from juror cards or other data observed by the lawyer, data provided by the court, data observed by jury consultants, or data obtained through research of secondary systems and databases not connected to this invention.

The system includes automated data entry for city and state for each juror. When a case is created, the default city and state can be defined so that users who are identifying prospective jurors do not have to re-enter the city and state upon each juror query.

The system allows for the creation of custom fields that may be defined for each case including Boolean Yes/No Fields, open text fields and numeric fields can be labeled and added to each case. The lawyer has flexibility to modify custom data fields by adding or removing fields at any time with the system, even after searches have been initiated.

Once a case is selected after the accessing the system via the Internet, all subsequent screens, juror data and processes will be tied directly to the selected case.

Cases and juror data can be referenced in the future by the lawyer or deleted. Entries for each case are automatically stored, but cases cannot be accessed by other users of the system who do not have access to those case files.

Identification of Jurors

The court provides the lawyer with a list of prospective jurors. Each juror typically has a “juror number,” which is used to identify jurors in voir dire.

The system allows for the rapid data entry, identification and background processing of juror names for multiple jurors on a single Web browser screen through the use of JavaScript. With JavaScript, data for each juror can be entered, and then the data for each juror can be stored in a central database. Searches can be executed simultaneously, and the user can rapidly move through the juror identification process without reloading data. Functions are executed by clicking buttons displayed in the Web browser, which trigger JavaScript functions. If JavaScript or equivalent system is not used, the Web browser would require more data downloads and screen refreshes, which would slow the process and require more data transfers.

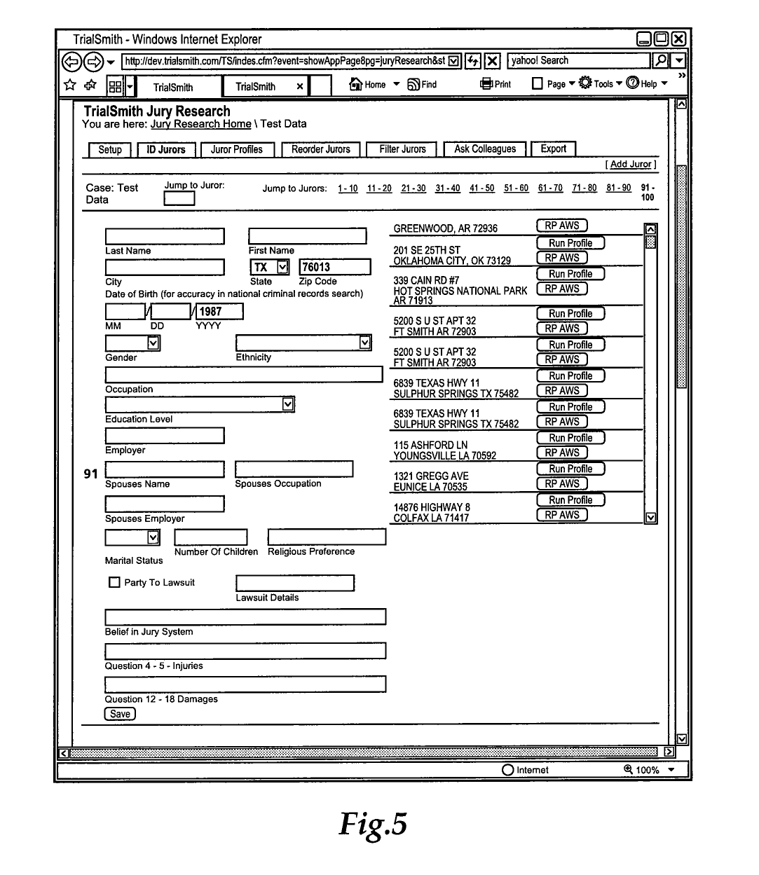

The system provides for a simple process that assists the user in accurately identifying each juror with a minimal amount of information in rapid succession with only a First Name, Last Name and State. The preferred method uses credit headers to aid in the initial screening as described below. Individual jurors may share common names within geographic areas, and this feature ensures that the correct individual is identified. For example, in FIG. 5 only the year of birth and the zip code is entered, and initial matches are shown on the right hand side of the screen for the user to quickly scan through those matches to see if the correct match is included. Additionally, the system allows for the provision of multiple users to identify and search jurors simultaneously, thereby increasing the speed at which reports can be processed for all jurors. For example, five or more different users can enter and simultaneously identify jurors using credit headers or another method.

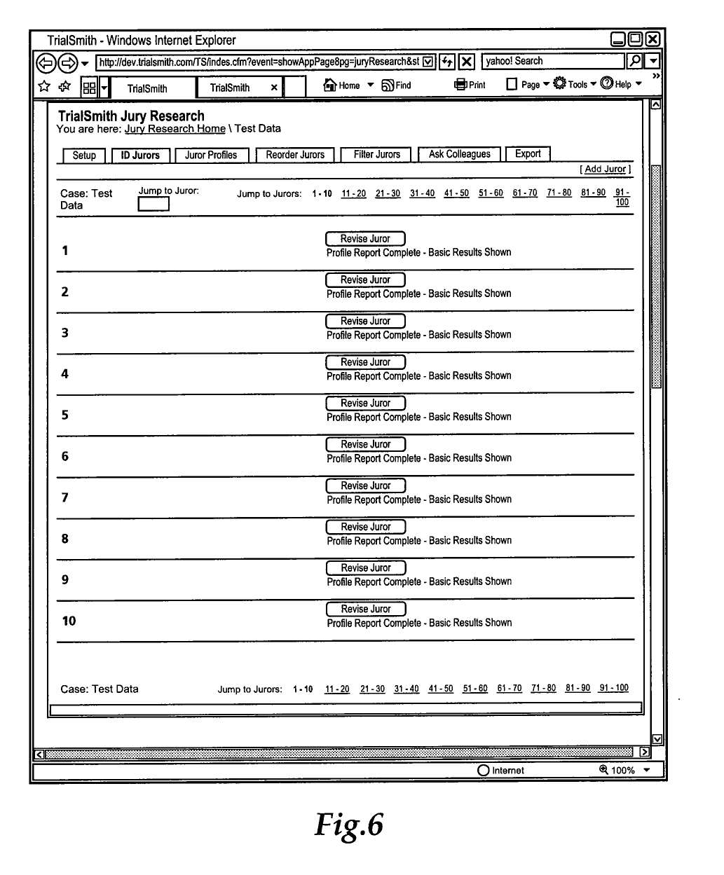

The system presents the user with list of juror numbers corresponding to the number of prospective jurors in the panel as defined by the user when creating the case, as shown in FIG. 6.

The user inputs only the First Name, Last Name and State of the juror in fields adjacent to the correct juror number as provided by the court. To better refine the initial identification search the user may optionally enter other information including the City, Zip code and Date of Birth.

A unique record is created for each individual juror entered by the user and it is critical that each juror be assigned the correct juror number.

The system allows the user to simultaneously enter other standard fields and/or custom fields at this point in the process, or to save time the user may enter data in other fields for each juror at a later time.

Once the user has entered only three (3) values for the juror, the system allows the user to select the type of report to process for the juror; different types of reports can be defined in the system. For example, one type of report may be “voter history only,” while another report may be more comprehensive, which could include all types of data and information from databases.

The system provides different pricing depending on the amount of information in the juror report. There is a billing component in the system whereby the type report selected by the user can be priced differently based on the sources of that data to be retrieved and other factors.

When the user selects the type of report based on the information desired for the juror or jurors, an initial identification search is processed using credit headers, and the user is instantly presented with a preview list of possible matches on the juror from credit headers or other public records databases without reloading the users screen.
a. The systems allows for the initial identification search to utilize a database of credit header information that contains both historical and current credit header information on all United States citizens obtained from major credit bureaus, and this is the most comprehensive set of information on individuals who may be jurors that is publicly available.
b. The system preferably utilizes credit headers because credit headers contain social security numbers, dates of birth and other “unique identifiers” that allow public record companies to accurately process reports on individual jurors.
c. Unique identifiers make it possible for third-party databases to quickly run full reports quickly and accurately based on the unique identifier for each juror.
d. If the credit header search does not result in an initial identification match on a juror, the system allows for use of voter history or other databases to run reports on the juror to match the information of the juror from the list provided by the court or entered into the database.

The system presents possible matches on the juror name including First Name, Middle Name, Last Name, Address, City, State, Date of Birth and estimated age.

The user then selects the correct match for the Juror Name from Public Records that matches the juror that has been empaneled by the court. The user can make a determination of the correct juror by using information on the juror information provided to the court, which may include a roster of jurors, the full legal name, address and possibly other juror information including date of birth. By comparing each juror on the jury list presented by the court with the possible matches identified in public records by the system, the user can more accurately match the juror to public records containing information on the juror.

The user selects the correct match on the individual juror by clicking a button on the screen adjacent to the correct match on the juror and
a. the juror's unique record in the database is updated with the jurors First Name, Middle Name, Last Name, Address, City, State Zip and Date of Birth for each individual juror entered by the user preferably with the juror number assigned by the court for ease in correlation of the data retrieved;
b. the system begins background processing based on the juror's unique identifier in credit headers and that process is executed using JavaScript that notifies the main server that searches are ready to be processed.

The user can immediately proceed to identify the next juror in public records without reloading the Web browser until all jurors are identified and without waiting for the main server to process the search.

A key benefit of this solution is the speed at which jurors can be initially identified and each juror search can be initiated. This is facilitated by the use of background processing once the juror is identified occurs using JavaScript, which allows the user to quickly move to identification of the next juror without reloading the browser or waiting for a search to complete.

Additional Methods for Initial Identification of Jurors

There are additional methods of the identification process that can be utilized with the system that allows for the import of a juror list in a standard comma-delimited format to reduce the time required to enter juror information into the system. Another method of the identification process utilized by the system is the user emailing or faxing the juror numbers and names to a third party for processing and preparing the juror reports according to the system described. The juror report can be transmitted via the Web by email or other transmission method to the user.

The system may also be used for juror identification by uploading a list of Juror Numbers and Drivers License Numbers for processing background reports on each juror.

Alternatively, the user can upload a list of Juror Numbers and Social Security Numbers for processing background reports on each juror.

Also, the system provides for user to text a message in a given sources format to various sources for processing background reports for a juror.

In another embodiment there is a general public records search. Third-party Web sites and databases can be used to perform various searches of public records on individuals based on unique identifiers related to individuals including social security numbers, dates of birth and other uniquely identifying information. There are no limits to the number of databases that could be queried from third-party sources once identified. The system may employ duplicate databases from multiple sources to ensure the broadest collection of information relevant to each juror.

Processing Juror Reports

The main server receives a request for each juror to identify each juror and to process a report with the requested parameters.

Based on data already captured in other processes of identifying the juror, the main server uses the juror's Unique Identifier, First Name, Middle Name, Last Name, Address, City, State, Zip Code, Date of Birth or other information to initiate searches at multiple databases.

The main server sends a request to process a background report via the Amazon Simple Queue Service (SQS) or other equivalent processing services. In this embodiment, each computer in the Amazon EC2 (Elastic Compute Cloud) watches the queue for a background report request. The request is then split up into multiple queries. Each query runs in a separate thread. The cloud allows the queries to be split up and run simultaneously.

The query is sent to a vendor such as Amazon Simple Queue Service (SQS) or another web service API by Simple Object Access Protocol (“SOAP”) or Representational state transfer (“REST”). The web service then provides a query interface to search for juror specific data. Each vendor typically has its proprietary query request. The request should contain the juror information necessary to elicit background information from databases, namely a Unique Identifier, first name, last name, city, state and zip code of residence. The vendor system will send the query response and obtain the results of the search. The full response is stored on a disk or drive with the naming convention of Juror ID-QueryType.DataType. The juror ID is the unique identifier in the system. The Query Type identified the vendor query. The Data Type identifies the type of data format returned and can be supported by text, XML and JSON.

The response data is parsed using a program such as Cold Fusion's parser. During the parsing of the response data on each juror, the code filters out any data deemed extraneous or not suitable for the juror report. The system has rules to parse the data created by analyzing vendor response data and formulating the filters to provide the relevant juror information. The responses are transmitted via the system's web service to the user. The system formats the data into the tables, logs or other format requested by the user. The system also updates the billing records.

The juror report process is conducted with simultaneous searches of multiple internet locations and databases using multiple computers via cloud computing. Generally speaking, the term “cloud computing” means Internet based development and use of computer technology where the computing is conducted remotely. It is a style of computing where information technology-related capabilities are provided as a service, and users can access this service over the Internet without having to invest the initial capitals for the hardware and software behind the computing service. In other words, cloud computing is a general concept that incorporate software as a service where users can rely on the Internet to satisfy their computing needs.

The system allows for the each individual selected for each report to be entered into a server report queue. The system allows for the addition of other databases and Internet sources to be added to this report queue. Each reporting system waits for new queries to be processed. For example, one reporting system is waiting for comprehensive background reports to be retrieved from a public records company, while a second reporting system is waiting to receive requests to process voter history searches in a separate system or database, while yet another reporting system may be assimilating information about the individual from Web sites or government databases.

The central system gathers reports in a queue to be processed and can intake an unlimited number of report requests. Utilizing cloud computing, reporting systems or other servers locate background reports to be processed based on the type of report requested. Servers then run queries on each individual selected utilizing third-party databases, search engines and internal databases to retrieve reports.

The system allows for reports to be processed simultaneously rather than consecutively. This speeds the background report process and allows for multiple searches to occur at the same time, while the user's browser and computer are unaffected. This dramatically improves the performance of all searches by using multiple processors on multiple servers.

The system allows for the retrieval of background data in XML format, JSON format, HTML format or other common formats that can be parsed using different methodologies to field or group the results into a format that a centralized server can store in a central database for each juror.

When all reports are complete for a juror, the main database is updated and the user's Web browser is notified that the report is complete utilizing a JavaScript function.

Juror reports are performed in “cloud computing.” This allows an unlimited number of servers to be activated to process queries, collect data in XML or other preferred (XML is used herein as a preferred embodiment) format, extract data from the xml, parse out data desired for storage in the juror's record, convert data to new XML format, queue data in “cloud” for transmission to Juror database at the systems operation center, data transferred via XML and placed in the juror's record, and finally the lawyer is notified through AJAX.

Since the juror reports can be compiled as quickly as they may require, utilization of cloud computing allows the system to scale the number of necessary servers to run juror searches simultaneously without affecting CPUs, processing or other Web services provided to end-users. This increases speed, efficiency and overall system performance. The lawyer is immediately notified through the Web interface that the juror profile is complete. The user can view each juror's record separately online via the wireless device supporting WAP protocol, or the lawyer may print the data obtained in the report through a PDF, or the lawyer may export the data into Excel format.

Identifying Juror Information in Other Networks

After all jurors are identified for background processing in the system, and either before or after reports are completed, the system allows the user to instantly trigger a secondary service that allows the names of the individual jurors identified to be compiled into an single email message and sent to a list server or similar email distribution list for review by the recipients of the list server. Recipients could include lawyers, paralegals and trial team members, jury consultants and other constituents related to the case. The system only allows names to be distributed to protect the privacy of prospective jurors. The user may also add questions, notes or other information prior to sending this email. The purpose of this process is to expand information gathering to a network of lawyers within a community who may have connections or awareness of prospective jurors.

Viewing Output Reports

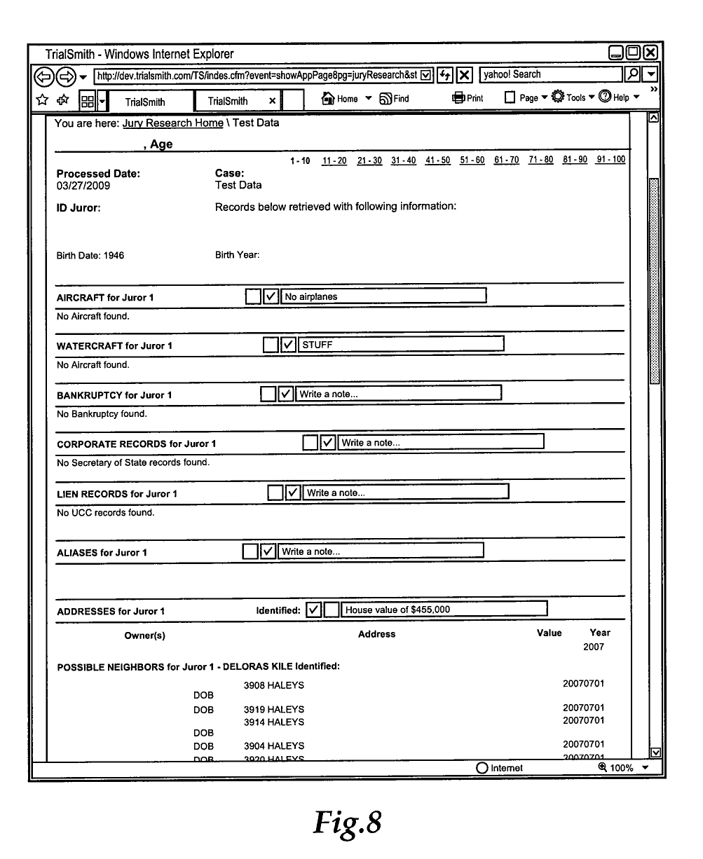

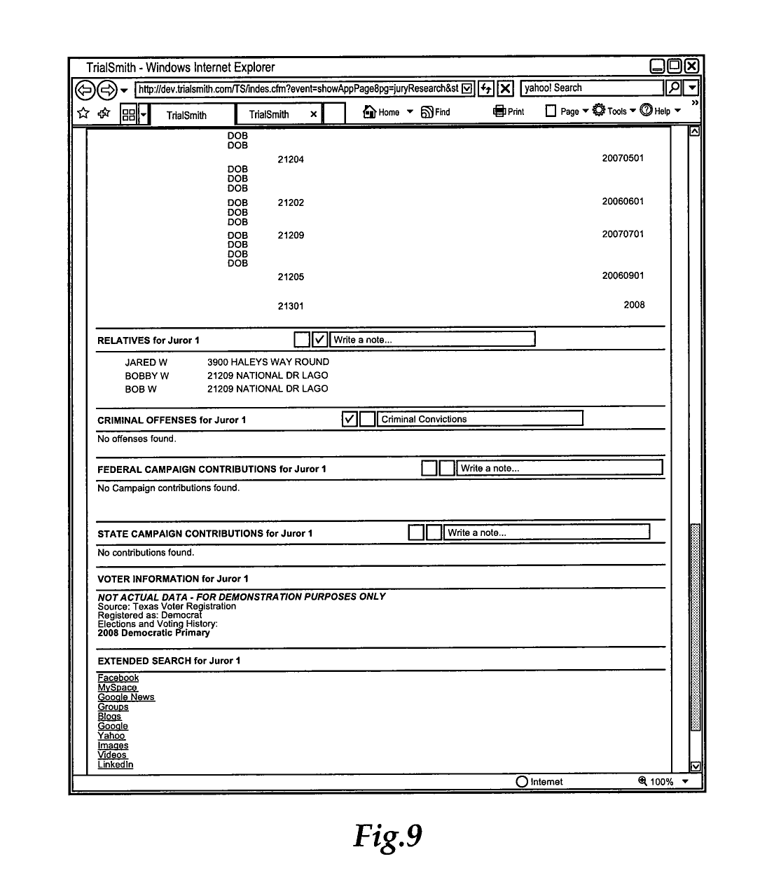

In another embodiment a report is created once the juror has been identified. The system is instructed by the user to perform a report on each juror. (See FIGS. 8 and 9) The number of databases and third-party databases that can be searched are not limited to any finite list of public record databases.

At the time of processing each report, if public records are found in any database or information source, a short note can be entered on each juror's summary screen indicating to the lawyer that records have been found. For example, if a prospective juror had no public records found, the summary data would indicate nothing was found. Whereas if the juror had a prior bankruptcy, the user would be alerted with “Bankruptcy Found” in the overall profile report of the juror.

The report data that is retrieved from reports by the system and stored in the juror's profile report can be edited by the user when viewing detailed notes, allowing complete flexibility. This note feature saves time by allowing the user to add annotations to report data and focus other trial team members' attention on jurors who may have potentially relevant information in their public records.

In another embodiment there is a method for analyzing the report for each juror. This provides a streamline system for analyzing all detailed background data that was retrieved in a public records search. Lawyers can open the full report on each juror. (See FIGS. 8 and 9) The report contains an aggregation of data organized by search area with results from all databases and searches. Data retrieved from third-party databases and internal databases are parsed for critical information, which is then displayed in a summary report.

Each section of the report contains a NOTE area where comments can be entered by the lawyer. For example, in the Federal Election Commission section, the lawyer could study the data and type “Contributed more than 32K to Rep Campaigns.” The lawyer's notes roll up to the summary page on each juror making it easy to study the information at a glance. The lawyer can quickly navigate back to a specific juror's screen, or jump to a range of jurors by juror number. This report can be printed for any juror. The report contains links to a report on the juror's spouse (if applicable) and reports on the juror's neighbors (if applicable).

Defining Sources and Queries for Background Reports

The system allows for the creation and definition of various queries for public records databases, internal databases, Web sites, and other databases that can be accessed and searched simultaneously over the Internet.

A unique design of this system is to incorporate data from disparate sources to ensure the most comprehensive set of data available for each juror.

A unique design is to allow simultaneous queries of multiple systems to speed processing.

Each source or database queried may have different requirements for searching, different access methodologies, different methods for capturing data, and different methods for interpreting data, and different methods for storing data in a central database.

The system is designed to accommodate multiple data sources as well as data types and to do so simultaneously.

Each query defines the database or resources to search, the type of data that is expected to be stored and how that data should be stored in the main system. The web service on the main system is responsible for receiving and saving the data in the storage system and adding transactions to the billing system.

A Description of Possible External Databases, Internal Databases, Public Records Services, Web Sites and Other Sources Used the Juror Report.

As shown in FIG. 9, various records of the juror can be revealed, including criminal records, federal campaign contributions, state campaign contributions and voter information. In an embodiment of this invention voter records are searched. Third-party Web sites or internal databases can be used to search for detailed voter history and voter information for each prospective juror. The search can include voter history and voter information for each prospective juror's spouse, significant others, family members or other individuals living with the juror. Depending on jurisdiction, the search can identify the voter's political party, identify elections the voter has participated in, and identify voter behavior and profiles.

In another embodiment Federal Campaign Contributions can be tracked. The Federal Election Commission or other third-party Web sites can be used to scan for each juror's federal campaign contributions. The value of contributions and to which campaigns the juror made a contribution can be reviewed and reported. Lawyers can makes notes about the campaign contributions found in order to provide an easy mechanism to summarize the information.

In another embodiment criminal offenses can be revealed. Third-party databases can be used to search each juror's record for state and federal criminal convictions and deferred adjudication. Records may be national in scope. Lawyers can makes notes about the criminal offenses found in order to provide an easy mechanism to summarize the information.

In another embodiment professional disciplinary actions can be revealed. Professional disciplinary actions in the juror's state can be searched to determine if the juror has ever been sanctioned professionally for any violations. These may be in the medical field, and all other professional licensed fields of practice. Records will be national in scope. Lawyers can makes notes about disciplinary actions found in order to provide an easy mechanism to summarize the information.

In another embodiment expert witness activity can be tracked. Each juror name can be searched against Expert Names databases to determine if the juror has ever testified as an expert in a case. Records will be national in scope and may include various sources including expert services Web sites. Lawyers can makes notes about expert information found in order to provide an easy mechanism to summarize the information.

In another embodiment judgments involving prospective jurors can be reviewed. Prior lawsuits and judgments are searched for matches for each juror's name. Records will be national in scope. Lawyers can makes notes about judgments found in order to provide an easy mechanism to summarize the information.

In another embodiment information on the relatives of a Juror can be reviewed. A list of possible relatives will be identified for each juror using the same tools. The relatives can include name, address and phone number of relative. The search can be national in scope. Lawyers can makes notes about relatives found in order to provide an easy mechanism to summarize the information.

In another embodiment property owned and the addresses of a juror can be reviewed. A list of all possible properties and addresses can be identified for each juror. The scope will be national. Homes, if found, will contain home values based on tax records. Lawyers can makes notes about property and addresses found in order to provide an easy mechanism to summarize the information.

In another embodiment possible neighbors can be located. A list of possible neighbors is identified for each juror. The list of neighbors can include the neighbor's names, year of birth, address, telephone number and any other publicly available information. Lawyers can makes notes about neighbors found in order to provide an easy mechanism to summarize the information.

In another embodiment a list of possible alias for each juror can be produced based on the juror's social security number linked to names other than the juror. The search can be national in scope. Lawyers can makes notes about aliases found in order to provide an easy mechanism to summarize the information.

In another embodiment liens for a juror can be located. A list of possible liens can be produced for each juror. Liens including the state, county, type of lien, and date, including names and details of the liens found. The search may be national in scope. Lawyers can makes notes about liens found in order to provide an easy mechanism to summarize the information.

In another embodiment corporate records are revealed. A list of possible corporations associated with each juror can be identified. Corporations can include the state, corporation name, status of charter, and type of corporation, year incorporated, including DBA name, charter number, and officers, directors. The search may be national in scope. Lawyers can makes notes about corporate records found in order to provide an easy mechanism to summarize the information.

In another embodiment bankruptcies can be located. Each juror's name can be scanned for all bankruptcy records to identify potential bankruptcies. The search may be national in scope. Lawyers can makes notes about bankruptcies found in order to provide an easy mechanism to summarize the information.

In another embodiment the ownership of watercraft, aircraft and/or motor vehicles can be added to the report on a juror, as shown in FIG. 8. Each juror's name can be scanned for all records for possible ownership. The search may be national in scope. Lawyers can makes notes about watercraft found in order to provide an easy mechanism to summarize the information.

In another embodiment, drivers license records may be searched. Each juror's name can be scanned for all driver's license records for possible matches. The search may be national in scope. Lawyers can makes notes about drivers license records found in order to provide an easy mechanism to summarize the information.

In another embodiment an author and blog search can be made. Journals, blogs and publications can be searched to determine if the juror has authored articles. The search can be international in scope and multiple databases are utilized. Lawyers can makes notes about author records found in order to provide an easy mechanism to summarize the information.

In another embodiment state campaign contributions can be reviewed. Using state ethics commission and other state databases, political contribution history for jurors can be viewed. The information will include the amount of the juror's contributions and the candidates who were given contributions by the juror. Lawyers can makes notes about the campaign contributions found in order to provide an easy mechanism to summarize the information.

In another embodiment maps and neighborhood photos can be used. A link is automatically provided from each juror's name to a street view on Google or other similar site. The view also gives the lawyer the option for the “street view,” thereby viewing the quality of homes, the type of neighborhood and other factors, which may be relevant in the case.

In another embodiment magazine subscriptions are accessed. Juror name can be processed against magazine subscription database to identify interest or sociographic characteristics of potential jurors. The search may be national in scope. Lawyers can makes notes about magazine subscriptions found in order to provide an easy mechanism to summarize the information.

Another embodiment includes an automated background assessment of the juror's spouse and family members. This feature allows the lawyer to run a deeper scan of the juror's spouse to determine if any factors in the spouse's public record could affect the bias of the juror. Using the system for juror identification described above, lawyers have the option of simultaneously identifying the spouse or family members of the juror in question or any other persons living with the juror. The databases may identify family members who do not live at the same address as the juror. The system may also identify former spouses of the juror, which can be analyzed. In the setup of each trial, the lawyer indicates if he prefers more thorough scans to be conducted on family members.

Lawyers can then obtain information on other family members when they identify the juror, and those searches can be simultaneously performed utilizing all of the same public records databases that are used for each juror. Public records found for spouses and family members are automatically assessed by the system so that the lawyer can quickly determine if the juror's family information have background information, which may affect the bias of the juror.

Another embodiment is an automated background assessment of the juror's neighbors. This feature allows the lawyer to run a scan of the juror's neighbors and their residence to determine if any potential factors in the juror's could affect the bias of the juror. In the setup of each trial, the lawyer indicates if he prefers deep scans to be conducted on neighbors. Neighbor scans are performed after the initial in-depth scan is performed on the juror as an optional tool. If the juror warrants further investigation, the lawyer can click a button to have the system perform additional in-depth background checks on all neighbors. Public records found for neighbors are automatically assessed by the system and summarized so that the lawyer can determine information about any nearby neighbors that may be relevant to the juror.

Incorporation of Search Engines and Social Media

A comprehensive list of Web sites, social media sites and other resources can be provided in a list of links in each Juror's report. Each link parses search terms automatically, typically the juror name and city of residence. There is no limit to the number of possible Web sites, which could be defined for each juror's report.

The user can save time by simply clicking on any social media sites or search engines and having a search automatically performed on the juror. For example, selecting “Google News” would launch a new window and display all news articles having the Juror's First and Last Name in the city where the juror resides.

The system will optimize how searches are performed on Web sites to refine the number of matches in an attempt to limit results to each specific juror. Placing the juror's name in quotes, followed by their city mailing address is much more likely to identify and target information related to that specific juror. These optimizations help lawyers more quickly view results from the Web without having to perform separate searches.

User can make notes about records found on social media Web sites and those notes are stored with each juror, simplifying the ability for the lawyer to summarize data that is found online.

Automatic calculation of the number of hits or search matches can be attached to each Web site and Social Media site. During the searches performed automatically by the servers, each search engine and social media site is polled to calculate the number of possible search hits for each juror. The number of search hits for each juror is stored in each juror's report.

Searching Juror Data

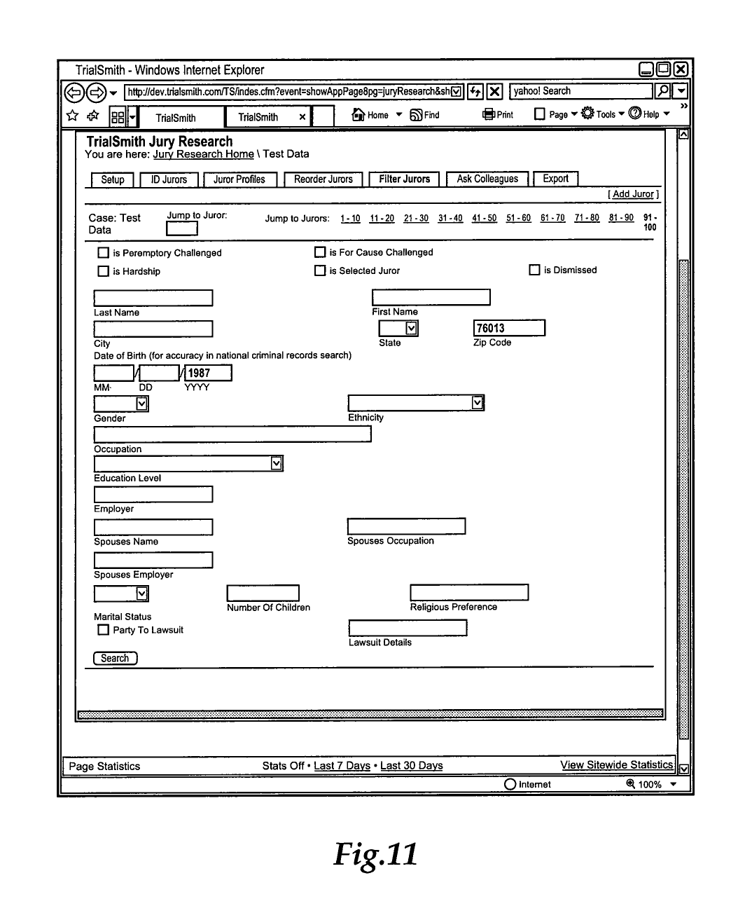

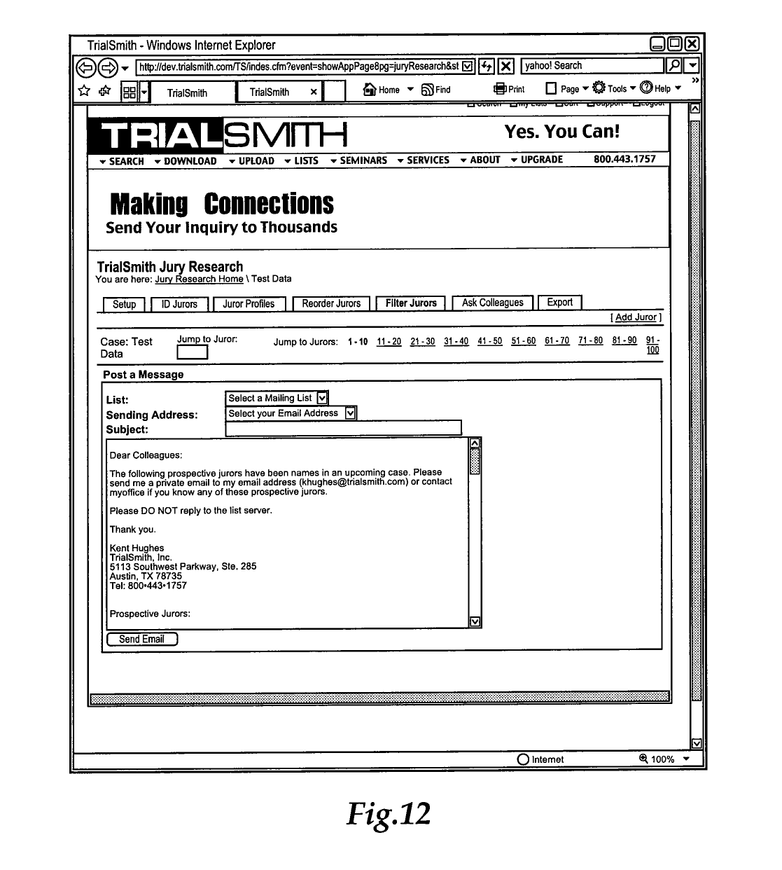

In another embodiment is a juror filtering feature. The system provides a search of the jury pool for specific factors or information from the juror card, the juror's background data, or from other data input by the lawyer into the system. Lawyers can quickly produce a list of jurors based on any facts or background information that has been found for a juror. For example, a lawyer could ask to produce a list of jurors with or without a demographic, economic or other attribute and the list could be instantly produced. (See FIG. 11) Filtering produces results in the uniform juror screens that are used to manage the jury list making it easy to navigate the information and switch between juror records. The lawyer or those assisting can prepare a filter in advance or at the time of selection to identify juror attributes.

Adding Notes and Annotations to Juror Records

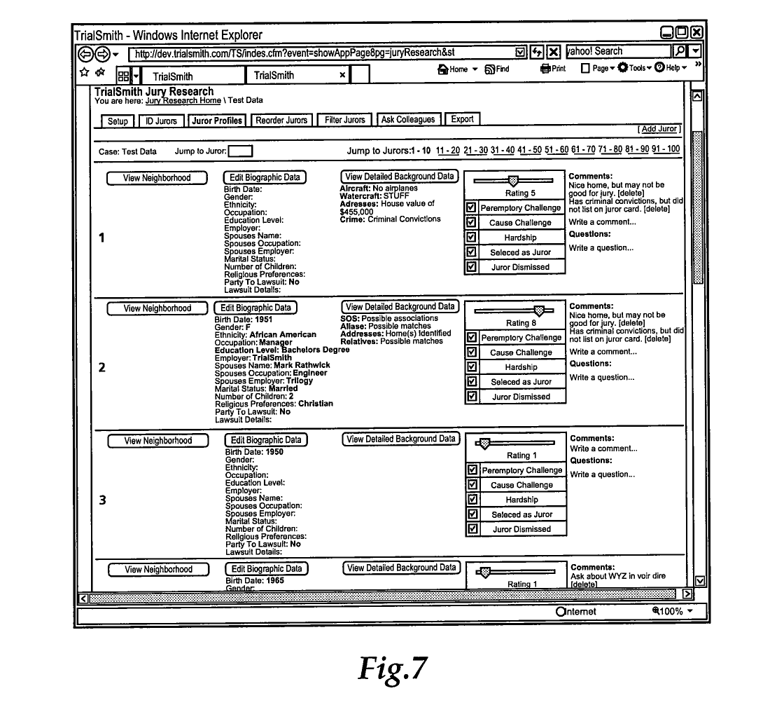

The system also provides for a method for including lawyers or user comments to make notes about each juror. On the overview page for each juror, lawyers can instantly add notes to each juror's record. (See FIG. 7) These notes may contain any summary information that the lawyer, paralegals or jury consultants wish to record. This could be responses to questions or notes about the juror's mood or disposition, opinions from jury consultants, or others assisting in the case. The system allows the user to toggle easily between jurors by simply entering the juror number and pressing enter. This allows the computer operator to jump quickly from juror to juror in order to enter questions. Using AJAX type functionality, the lawyer may add notes without having to click the save button or reload the Web page.

Adding Juror Questions to Each Juror

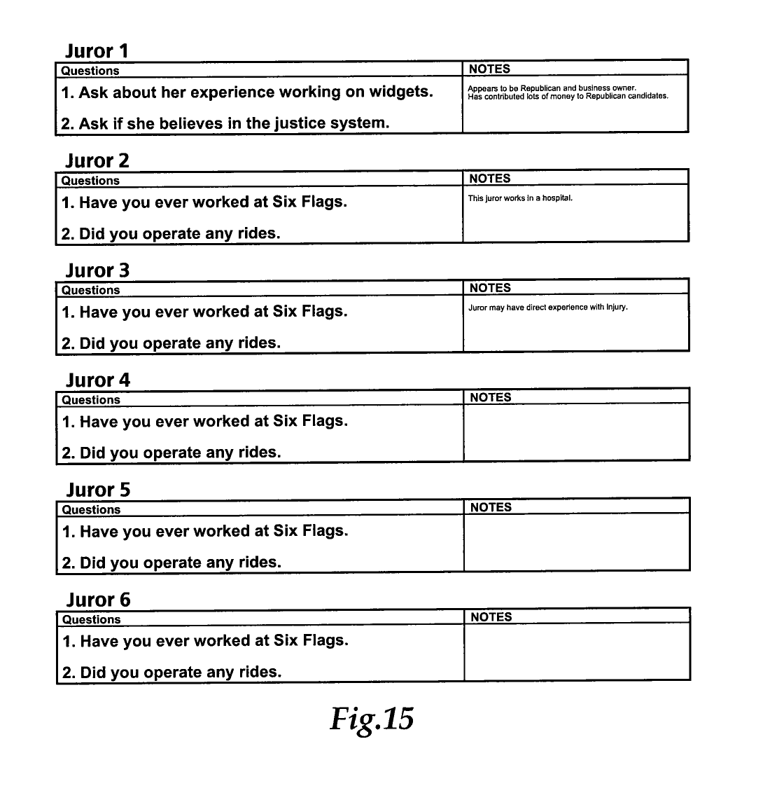

The system also provides for a method to include juror questions with a system for lawyers to create questions to ask of jurors during voir dire. On the overview page for each juror, lawyers can add questions they wish to ask the juror during voir dire. (See FIG. 7) Juror Questions can be exported into a separate report for the lawyer conducting voir dire making it easy for the lawyer to ask focused questions during voir dire, as shown in FIG. 15. The lawyer's trial consultants, paralegals or remote consultants can review the juror's information and submit questions instantly using this tool.

Printing Juror Reports

A print function provides a simple way to print a list of juror names with questions in large type. The lawyer conducting voir dire can easily refer to the questions that are being drafted by one or more colleagues. This allows the computer operator to jump quickly from juror to juror in order to enter questions. Using AJAX type functionality, the lawyer may add questions without having to click the save button or reload the Web page after each entry.

The system also provides for juror status toggles with a system for lawyers to define the status of each juror during voir dire. Various toggles have been defined to indicate the status of each juror. (See FIG. 7) A rating tool allows the lawyer to drag and drop a rating scale from 1 to 10 for each juror. There are status toggle flags for peremptory challenge, cause challenge, hardship, selected as juror and juror dismissed. When a juror is dismissed, the specific juror's on-screen record is minimized and condensed to a single line on the screen. All other users in multiple locations are notified that the dismissed juror no longer appears as a juror who should be analyzed. Jurors who are toggled as “Dismissed” are hidden or minimized in the juror's record from the list of prospective jurors.

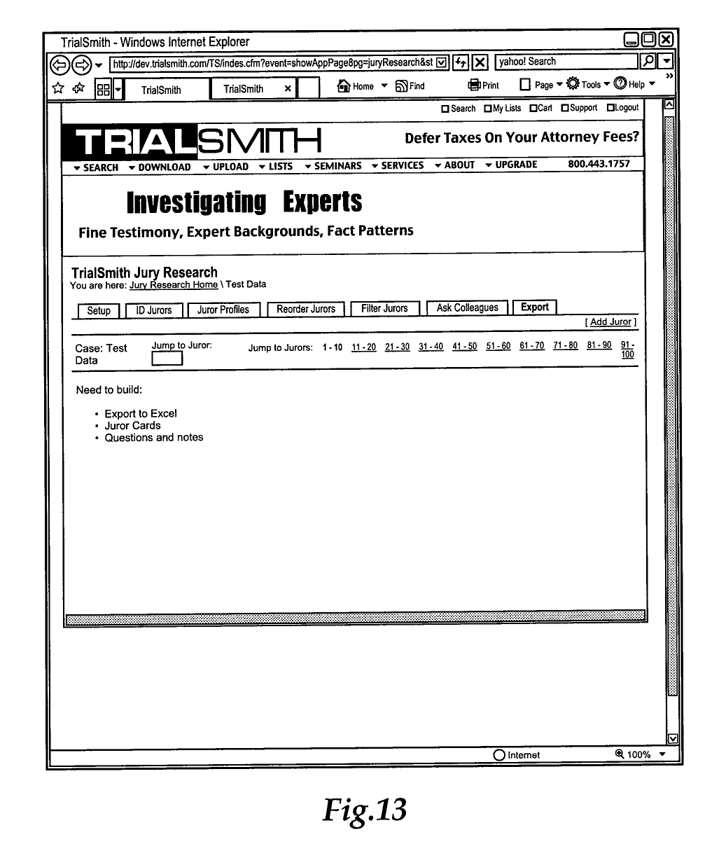

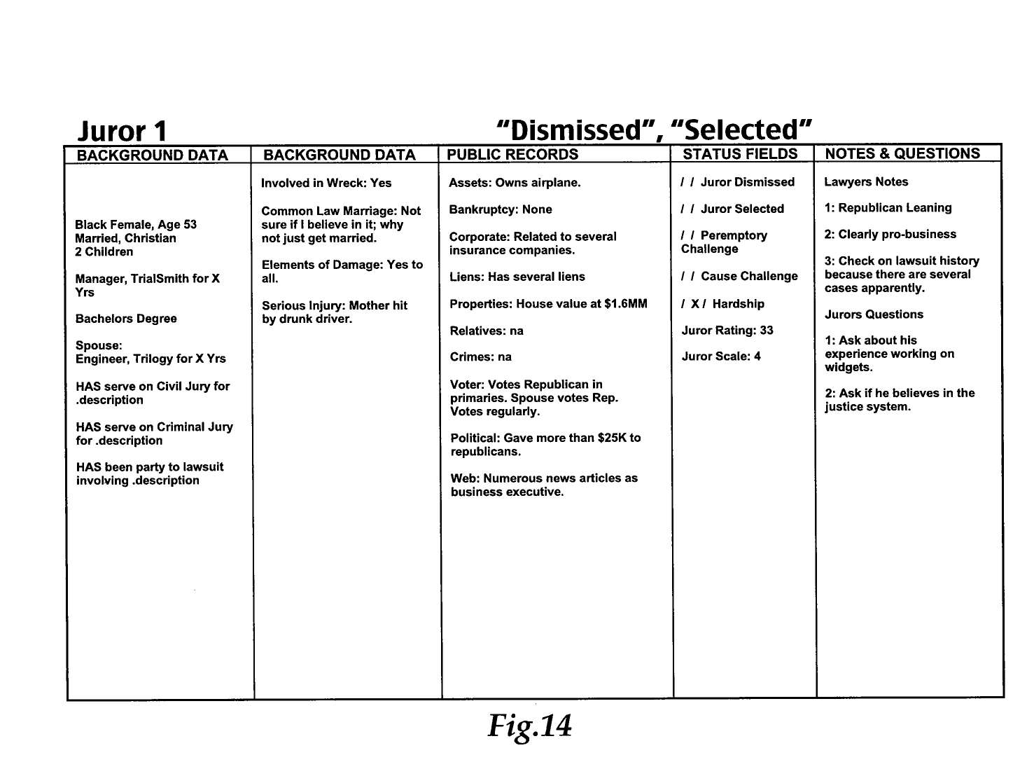

Another embodiment of the invention is the reporting features that provide a system of exporting data from the jury research system. As shown in FIG. 14, detailed juror cards can be printed on large index cards. The cards contain all selected summary data. (See FIG. 13) Data can be exported and customized by the lawyer. For example, if a custom formatted juror card is needed, or a special report or other item is needed, exporting to Excel or other tabular format allows customization by the user. Exporting data to Excel also allows the lawyer to edit and study the data offline. In addition, exporting the data to Excel allows the lawyer to customize reports and integrate data from other systems. Juror Reports can be downloaded for offline review for each juror. Custom reports can be written for each case.

Re-Numbering Feature

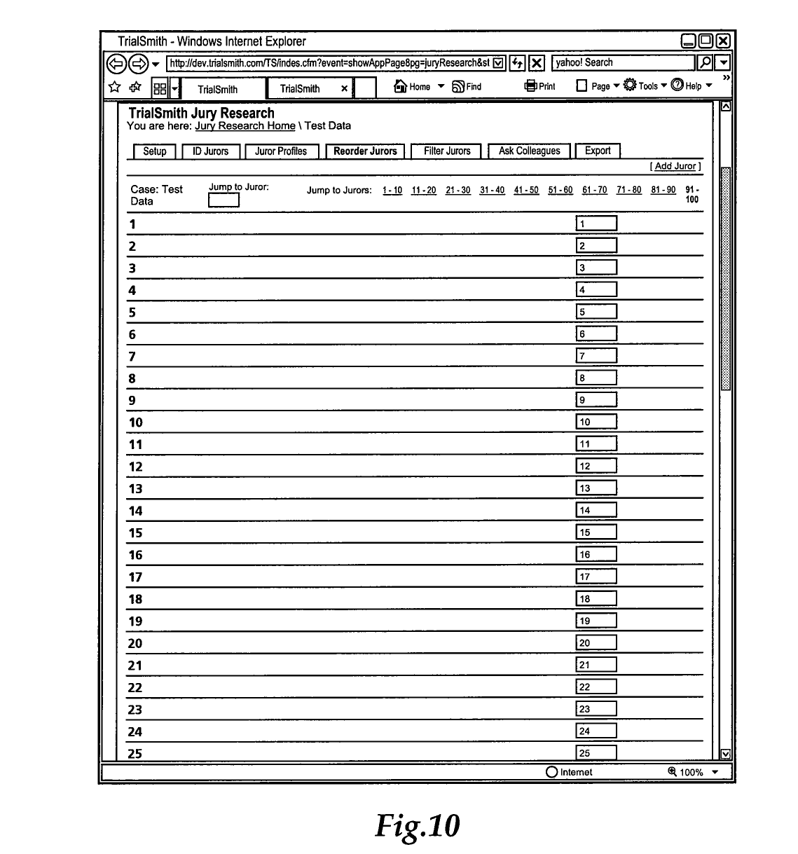

The system provides the user the ability to re-number jurors using a special juror renumbering tool. The tool presents a list of all current juror numbers and juror names that have been assigned to each number. The user can simply enter the new number for each juror and click a button to “renumber” all jurors. Renumbering jurors is a common practice in courts. (See FIG. 10)

Online Chat for Users

The chat tool allows all lawyers, paralegals and trial consultants within the jury system to instantly send messages to each other, without having to leave the jury system. Messages may include warnings, special questions, notes about findings, or other information that can be instantly exchanged. The messages of the chat tool are instantly viewed on all screens and all Web browser of users working on the case in real time. Messages within the chat tool are permanently stored and can be scrolled for later analysis by the lawyers. However, individual messages within the chat tool may be deleted, if desired by the user.

Recording Juror Behavioral Patterns

An additional embodiment is a system for analyzing juror behaviors, physical attributes and body language to determine traits of the juror. FIGS. 2,3 and 4 show custom fields to hold data or other comments. The lawyer, paralegal or trial consultants may use the tool to record behaviors and physical clues about each juror during voir dire. The factors and traits identified for each juror also can be recorded by others observing their behavior during voir dire.

Refining Reports

An additional embodiment is a system for pre-selecting key public record variables that are desired in a public records search. For example, the user may only want to see which jurors are Democrat or Republican. In another example, a user may only want to retrieve information on jurors that are Republican and have a home valued more than a specific market value. The purpose of this embodiment is to red-flag or quickly identify key attributes that may be of significance to a case.

A jury research system that is flexible to integrate other jury research tools with an application programming interface. The system is designed with an API that allows for other jury research systems, methodologies, applications and databases to be integrated. The Web-based system allows access to these integrated services without the installation of additional software by end-users.

A jury research system that is software as a service with no installation, upgrades for ease of use for the user. While the jury research system is software, the jury research system is a Web-based solution that requires no installation. The invention can be licensed by lawyers and instantly activated online through a Web interface without costly setup fees. The lawyer can instantly define a case, the number of prospective jurors and begin research. No setup, configuration or activation is required by staff members.

FIG. 16A summarizes the steps of selecting a case, defining custom juror data, identifying all jurors, selecting juror and spouse in the first juror-identification process. In the second juror data analysis process, FIG. 16A also summarizes the steps of providing a jury summary page, providing a output juror report, adding notes and questions to the juror report, the optional steps of renumbering jurors, the optional steps of filtering jurors, exporting juror data, and activating colleague network.

FIG. 16B is a schematic showing the jury system central database. In the central database various mechanisms for identifying jurors are provided. After individual juror's name is saved in the central database, the search for preparing the output report is initialed in the cloud. The searched information from the cloud is then parsed in XML format and received by the central database. The smart analysis feature then automatically assesses the parsed data and generates a summary of the jurors' data, for example as shown in FIG. 7. After the output report is completed, the juror data is stored in the Central Database and the user is notified that the juror data is ready for analysis. Thereafter, AJAX updates the user's browser. Also to be noted is that non-users outside of the authorized network can have access to the list of jurors in the user's list servers.

FIG. 16C illustrates another embodiment of the jury research system of the present invention. In this figure, credit headers are used to identify jurors in a third party system, such as a credit bureau. Once the juror has been identified, the data and encrypted social security number of the identified juror is returned to the user. In the mean time, cloud computing is activated so that juror searches are initiated at different servers that may contain additional data regarding the juror. The completed juror report can be exported in various format or styles, depending on the user's need. For example, in FIG. 16C a user may choose to output the juror report in Excel format or as juror cards or juror questions, or the user may customize the data export with user-defined fields.

While the invention has been described with a limited number of embodiments, these specific embodiments are not intended to limit the scope of the invention as otherwise described and claimed herein.

1. A method for collecting and analyzing data on individuals through cloud computing, comprising the steps of:
a) inputting, from a local device, at least one identifier specific to at least one individual of interest in a query to at least one remote database, wherein said at least one remote database contains data of individuals and can be accessed remotely over the Internet;
b) searching with multiple computers via cloud computing said data of individuals from said remote database that matches the query;
c) collecting data of the matched individuals; and
d) parsing the collected data into a predetermined format to generate a output report sorted by the individuals of interest that is accessible via the Internet by at least one user.

2. The method of claim 1, wherein said at least one identifier is the first and last name of said individual of interest.

3. The method of claim 1, wherein said at least one identifier is the social security number of said individual of interest.

4. The method of claim 1, wherein said at least one identifier is the date of birth of said individual of interest.

5. The method of claim 1, wherein said local device is selected from the group of a computer and a mobile electronic device.

6. The method of claim 1, prior to step a), further comprising the step of:
a-1) creating a new case report or selecting an existing case report from a case database; and
a-2) inputting, from said local device, said at least one identifier specific to said individual of interest in a query to at least one identification database to obtain an initial identification of potential matches, wherein said identification database contains identification data of individuals.

7. The method of claim 6, wherein said identification database can be accessed locally or remotely over the Internet.

8. The method of claim 6, wherein said identification database is a database of credit header information.

9. The method of claim 6, wherein said case database contains the information of previous created case reports.

10. The method of claim 1, wherein said output report is editable by said at least one user.

11. The method of claim 1, wherein said output report is sharable by said at least one user through e-mail.

12. A method for collecting and analyzing data on individuals through cloud computing, comprising the steps of:
a) creating a new case report;
b) inputting, from a local device, at least one identifier specific to at least one individual of interest in a query to at least one identification database to obtain an initial identification of potential matches, wherein said identification database contains identification data of individuals;
c) inputting, from said local device, said at least one identifier specific to said individual of interest in a query to at least one remote database, wherein said remote database contains data of individuals and can be accessed remotely over the Internet;
d) searching with multiple computers via cloud computing said data of individuals from said remote database that matches the query;
e) collecting data of the matched individuals; and
f) parsing the collected data into a predetermined format to generate a output report that is accessible by at least one user.

13. The method of claim 12, wherein said at least one identifier is the first and last name, the social security number, or date of birth of said individual of interest, or the combinations thereof.

14. The method of claim 12, wherein said local device is a computer or a mobile electronic.

15. The method of claim 12, wherein said identification database can be accessed locally or remotely over the Internet.

16. The method of claim 12, wherein said identification database is a database of credit header information.

17. The method of claim 12, wherein said case database contains the information of previously created case reports.

18. The method of claim 12, wherein said output report is editable by said at least one user.

19. The method of claim 12, wherein said output report is sharable by said at least one user.
